(19) United States
(12) Patent Application Publication
(10) Pub. No.: US 2026/0066721 A1
(43) Pub. Date: Mar. 5, 2026

(54) PERMANENT MAGNET ROTOR

(71) Applicant: BÜHLER MOTOR GMBH, Nürnberg (DE)

(72) Inventors: Jürgen Leykamm, Kirchensittenbach (DE); Jürgen Strüber, Nürnberg (DE); Jürgen Riess, Nürnberg (DE); Norbert Chemnitz, Nürnberg (DE); Katherine Bee, Nürnberg (DE)

(73) Assignee: BÜHLER MOTOR GMBH, Nürnberg (DE)

(21) Appl. No.: 19/343,268

(22) Filed: Sep. 29, 2025

Related U.S. Application Data
(63) Continuation of application No. PCT/EP2024/055798, filed on Mar. 6, 2024.

(30) Foreign Application Priority Data
Mar. 29, 2023 (DE) 10 2023 107 989.1

(51) Int. Cl. H02K 1/27; H02K 7/00

(52) U.S. Cl. CPC H02K 1/27; H02K 7/003

(57) ABSTRACT

Permanent magnet rotor comprising at least one laminated core which is formed from at least two sub-cores, wherein the laminated core has magnet-receiving pockets in which permanent magnets are received, wherein the laminated core has a receptacle for a motor shaft in its center, wherein each sub-core is formed by stacking individual laminations and wherein at least one permanent magnet projects from the magnet receiving pocket in at least one axial direction.

### CROSS-REFERENCE TO RELATED APPLICATIONS

This present patent application is a continuation application of PCT Application No. PCT/EP2024/055798 filed on Mar. 6, 2024, which is based on German Application No. DE 10 2023 107 989.1 filed on Mar. 29, 2023, all of which are incorporated by reference in their entirety.

### BACKGROUND OF THE INVENTION

### Field of the Invention

The invention relates to a permanent magnet rotor.

### DESCRIPTION OF RELATED ART INCLUDING INFORMATION DISCLOSED UNDER 37 CFR 1.97 AND 1.98

Permanent magnet rotors are used as an important component in electric motors that can drive fluid pumps, for example. Brushless BLDC motors are now often used in such applications. The use of permanent magnet rotors is known, in which pockets are provided within a laminated core stack (made of stacked and punched individual laminations) to receive and fix permanent magnets. Typically, the permanent magnets are arranged within the pockets in such a way that their axial length is adapted to the axial length of a laminated core of the permanent magnet rotor or is shorter and thus positioned behind the laminated core.

For manufacturing reasons, the laminated core after punching always has a significantly higher tolerance range than the permanent magnets. Permanent magnets positioned behind the laminated core lead to a reduction in the magnetic flux. Known permanent magnet motors are also limited in their design, especially with regard to the targeted design of the laminated core, which makes individual construction configurations difficult. Furthermore, there is a lack of means for targeted flow through the components if the electric motor is intended to drive fluid pumps in which the motor interior is flooded with a medium. Optimal or targeted heat dissipation of the motor components is generally not possible.

### BRIEF SUMMARY OF THE INVENTION

The object of the present invention is to propose an improved permanent magnet rotor which overcomes the aforementioned disadvantages, in particular enables an individually configurable structure and which increases the effectiveness of the magnetic flux. In addition, efficient heat dissipation via the medium should be achieved.

This object is achieved by a permanent magnet rotor comprising: at least one laminated core formed from at least two sub-cores, wherein the laminated core has magnet receiving pockets in which permanent magnets are received, wherein the laminated core has a receptacle for a motor shaft in its center, wherein each sub-core is formed by stacking individual laminations and wherein at least one permanent magnet projects from the magnet-receiving pocket in at least one axial direction.

A permanent magnet rotor comprises at least one laminated core which is formed from at least two sub-cores, wherein the laminated core has magnet-receiving pockets in which permanent magnets are received, wherein the laminated core has a receptacle for a motor shaft in its center, wherein each sub-core is formed by stacking individual laminations and wherein the permanent magnets project from the magnet-receiving pockets in at least one axial direction.

By the projection (or sticking out, or protruding from the end face) of at least one permanent magnet in at least one axial direction (i.e., on one side or both sides of the end faces of the permanent magnet rotor) from the magnet-receiving pocket, a forced media flow and media turbulence is achieved in the motor. The projecting permanent magnets act like vane tabs on the permanent magnet rotor and ensure the media flow and media turbulence. This creates a defined swirling and circulation effect similar to a paddle wheel pump. The circulation effect can be increased by having continuous channels in the rotor laminated core. It is also possible to have the permanent magnets protrude on both sides. With known permanent magnet rotors, in which the permanent magnets are flush with the laminated core, no circulation effect is possible.

An increase in the media flow is additionally achieved by introducing fluid channels in the stator. In wet-running motors, it is advantageous to circulate the medium surrounding the permanent magnet rotor in a targeted manner in order to ensure better heat dissipation from the stator and any electronics present.

Preferably, all permanent magnets should project in the axial direction on a common (radial) plane. The height of the projection or the extension of the permanent magnets can be individually adapted to the size of the laminated core or to the two sub-cores depending on the desired parameters of the motor. The permanent magnet rotor can be designed as an I-rotor, T-rotor or V-rotor, in most cases as an IPM (Internal Permanent Magnet) rotor or as an SPM (Surface Permanent Magnet) rotor.

The back-EMF (back-electromotive force) constant of the motor can be increased by increasing the magnetic flux density by lengthening the permanent magnet rotor with respect to the stator length, thereby increasing the motor power without increasing the overall dimensions of the motor itself. Since the rotor core is often punched in one go with the stator core, it makes sense for the permanent magnet rotor and stator to have the same length (i.e., the same number of individual laminations in the lamination core). If the permanent magnet rotor were longer than the stator, stator laminations would remain as waste during the punching process.

In order to nevertheless increase the magnetic flux density, in the sense of the present invention only the magnets are made longer than the laminated core. The laminated core is able to capture and utilize the magnetic flux of the protruding magnets. This allows the back-EMF constant of the motor to be increased while maintaining the same laminated core length of the permanent magnet rotor.

The motor shaft is pressed into a receptacle in the center of the laminated core after the two sub-cores are joined together. The laminated core can be overmolded with a plastic before or after the motor shaft is pressed in. The plastic overmolding serves to protect the laminated core from corrosion in the medium. Alternatively, the laminated core can be provided with a corrosion-resistant coating.

In a development, the individual laminations according to a first embodiment have at least one magnetic receiving pocket and at least one clamping tongue in the receptacle. At least one clamping tongue can flexibly align itself upwards or downwards in the axial direction when the permanent magnet is inserted. In addition, at least one clamping tongue enables a frictionally engaged and form-fitting fastening of the permanent magnet in the magnet-receiving pocket. For example, the permanent magnet can have a groove for a form-fit connection. The advantage of this fastening method is that additives such as glue are not required. In addition, it is also advantageous to dispense with a cover on the axial end faces of the laminated core, since the permanent magnets cannot fall out due to the clamping tongues. It is also possible to dispense with overmolding the laminated core after inserting the permanent magnets.

Particularly preferably, at least one fluid channel (and/or one fluid bore) is formed in the individual laminations. A fluid channel promotes the flow of the medium through the permanent magnet rotor, wherein at least one fluid channel is arranged at a distance from the receptacle for the motor shaft (for example, arranged concentrically) and forms an axial flow in the laminated core. In addition, at least one fluid channel is formed by a clearance fit of the permanent magnets and the at least one clamping tongue in the magnet-receiving pockets. Through the fluid channels and at least one fluid bore, media circulation takes place via these and an air gap between the permanent magnet rotor and a stator.

According to one embodiment, according to a second embodiment, the individual laminations form the receptacle in its circumference without interruption. This means that the receptacle has no clamping tongues or interruptions or elevations or the like. As a result, the circumference of the receptacle of the individual lamination according to the second embodiment is not in contact with the outer diameter of the shaft. In the case of a laminated core formed from individual laminations according to the second embodiment, the laminated core is overmolded with plastic after the shaft has been pressed in. Alternatively, the shaft can be fixed in the laminated core using fasteners (e.g., adhesives).

According to a further embodiment, the individual laminations according to a third embodiment form the receptacle with a larger radial diameter than in the second embodiment. This can be used, for example, to create a type of recess in the laminated core to receive a thrust washer or an additional bearing seat in this recess.

According to one embodiment, each sub-core is formed identically. Each sub-core has the same number of individual laminations according to the respective (first, second or third) embodiments. Alternatively, each sub-core can have a different number of individual laminations with different designs.

According to a further advantageous embodiment, each sub-core is formed from a plurality of individual laminations according to a first embodiment.

However, it is also conceivable that each sub-core is formed from a plurality of individual laminations according to a second embodiment.

It is also conceivable that each sub-core is formed from a plurality of individual laminations according to a third embodiment.

Furthermore, it is possible that each sub-core is formed from a plurality of individual laminations according to a first and/or second and/or third embodiment.

The aforementioned embodiments allow for an individual construction of the sub-cores through different combinations of the individual laminations according to freely combinable embodiments. This allows the laminated core to be individually adapted to specific motor requirements.

In an alternative embodiment, at least one individual lamination has at least one lamination tab on at least one axial end face of the laminated core, which tab extends in the axial direction from the laminated core. Within this example, the forced media flow and media turbulence can be achieved not by projecting permanent magnets but also by protruding lamination tabs, which are formed, for example, from or on the first individual lamination during punching. The lamination tab(s) may also be provided in addition to the projecting permanent magnet rotors and enable additional fixation of the projecting permanent magnet. The top individual lamination may differ from the punch cut of the other individual laminations.

According to a preferred embodiment of the invention, a part of the permanent magnets can be received in a first sub-core and a part of the permanent magnets can be received in a second sub-core and the first sub-core and the second sub-core can be joined together to form a complete and common laminated core. A part of the permanent magnets is inserted into the magnet-receiving pockets in the punching direction of the individual laminations. This means that the surface of the magnets is not damaged by the clamping tongues in the magnet-receiving pockets. When assembling the sub-cores, the second sub-core is also applied to the first sub-core in the punching direction to prevent damage to the permanent magnet. A further advantage of dividing the permanent magnets into two sub-cores is the easier magnetization of the permanent magnets in the respective sub-cores. In an alternative embodiment, it is also possible to mount all permanent magnets in the first or second sub-core and then attach the other sub-core to the magnets.

It is particularly advantageous to have a thrust washer mounted on the motor shaft. The thrust washer enables smooth start-up of the permanent magnet rotor and limits its axial play. The radial dimensions of the thrust washer correspond to the radially enlarged diameter of the third embodiment already described (or are smaller than this).

In particular, it can be provided that the permanent magnet rotor is used in an electric motor. Preferably this is a BLDC motor. However, the invention should not be considered limited in this respect, but should cover all possible types of usable motors.

The permanent magnet rotor is particularly preferably used in a fluid pump. It is also conceivable to use the permanent magnet rotor in an electric drive for fluid pumps or for actuators or servo motors If the magnets are arranged in a T-or V-shape, there is an unused space in the center towards the shaft, which consists only of unusable sheet material.

To reduce the weight of the parts and to make better use of space, the rotor can be provided with recesses at both ends at this point. This creates space for the arrangement of bearings, some of which extend into the permanent magnet rotor.

### BRIEF DESCRIPTION OF THE SEVERAL VIEWS OF THE DRAWINGS

The invention is explained in more detail below with reference to exemplary embodiments and accompanying schematic drawings. In the figures:

FIG. 1 shows a perspective view of a permanent magnet rotor according to an embodiment;

FIG. 2 shows a sectional view of a permanent magnet rotor according to FIG. 1;

FIG. 3 shows a further sectional view of the permanent magnet rotor according to FIG. 1;

FIG. 4a-c show detailed views of individual laminations according to a first, second or third embodiment;

FIG. 5 shows a perspective view of a permanent magnet rotor according to a further embodiment.

### DETAILED DESCRIPTION OF THE INVENTION

FIG. 1 shows a perspective view of a permanent magnet rotor (1) according to an embodiment. The permanent magnet rotor (1) comprises at least one laminated core (2) which is formed from at least two sub-cores (3, 4). The laminated core (2) has magnet-receiving pockets (5) in which permanent magnets (6) are received. The laminated core (2) has a receptacle (7) for a motor shaft (8) in its center. Each sub-core (3, 4) is formed by stacking individual laminations (9) and at least one permanent magnet (6) projects from the magnet-receiving pocket (5) in at least one axial direction. Each sub-core (3, 4) is identically designed. Alternatively, it is also possible to design each sub-core differently. A thrust washer (12) is received on the motor shaft (8). Alternatively, an additional bearing can be received on the motor shaft (8).

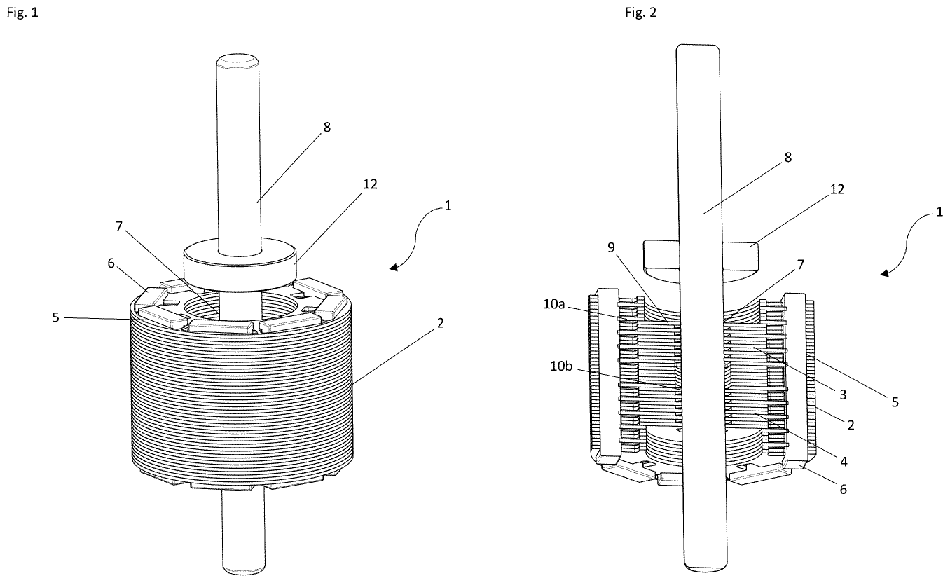

FIG. 2 shows a sectional view of a permanent magnet rotor (1) according to FIG. 1. The permanent magnet rotor (1) comprises at least one laminated core (2) which is formed from at least two sub-cores (3, 4). The laminated core (2) has magnet-receiving pockets (5) in which permanent magnets (6) are received. The laminated core (2) has a receptacle (7) for a motor shaft (8) in its center. Each sub-core (3, 4) is formed by stacking individual laminations (9) and at least one permanent magnet (6) projects from the magnet-receiving pocket (5) in at least one axial direction. Each sub-core (3, 4) is identically designed. Alternatively, it is also possible to design each sub-core differently. A thrust washer (12) is received on the motor shaft (8). Alternatively, an additional bearing can be received on the motor shaft (8). Each sub-core (3, 4) is formed from a plurality of individual laminations (9) according to a first (A), second (B) and third (C) embodiment. Alternatively, at least one sub-core (3, 4) can be formed from a plurality of individual laminations (9) according to a first (A) embodiment or according to a second (B) embodiment or according to a third (C) embodiment. In an alternative, at least one sub-core (3, 4) can be formed from a plurality of individual laminations (9) according to a first (A) and/or second (B) and/or third (C) embodiment. Thus, all conceivable combinations of the embodiments (A to C) of the individual laminations to form at least one sub-core (3, 4) are possible. The individual laminations (9) according to a first (A) embodiment have at least one clamping tongue (10a, 10b) in at least one magnet-receiving pocket (5) and in the receptacle (7). The at least one clamping tongue (10b) clamps itself to the motor shaft (8) and the at least one clamping tongue (10a) fastens the permanent magnet (6) in a frictionally engaged manner in the magnet-receiving pocket (5). The individual laminations (9) according to a second (B) embodiment form the receptacle (7) in its circumference (U) without interruption. The individual laminations (9) according to a third (C) embodiment form the receptacle (7) with a larger radial diameter than in the second (B) embodiment (B).

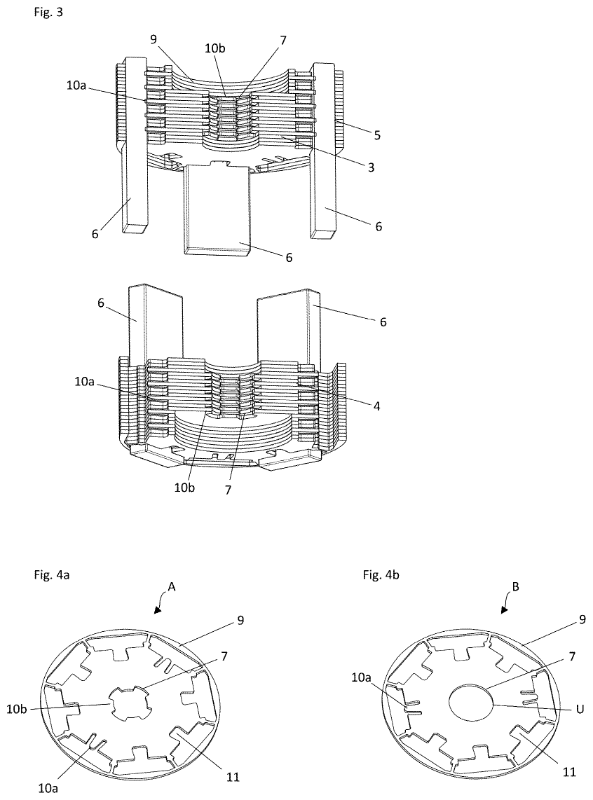

FIG. 3 shows a further sectional view of a permanent magnet rotor (1) according to FIG. 1. The laminated core (2) is made up of two identically designed sub-cores (3, 4). Each sub-core (3, 4) is formed from a plurality of individual laminations (9) according to a first (A), second (B) and third (C) embodiment. Alternatively, at least one sub-core (3, 4) can be formed from a plurality of individual laminations (9) according to a first (A) embodiment or according to a second (B) embodiment or according to a third (C) embodiment. In an alternative, at least one sub-core (3, 4) can be formed from a plurality of individual laminations (9) according to a first (A) and/or second (B) and/or third (C) embodiment. Thus, all conceivable combinations of the embodiments (A to C) of the individual laminations to form at least one sub-core (3, 4) are possible. A part of the permanent magnets (6) is received in a first sub-core (3) and a part of the permanent magnets (6) is received in a second sub-core (4). The first sub-core (3) and the second sub-core (4) are joined together to form a laminated core (2). Alternatively, all permanent magnets (6) can be received in the first or second sub-core (3, 4) and then the second sub-core (4) or the first sub-core (3) can be pushed or pressed onto all permanent magnets (6) and joined together to form a laminated core (2).

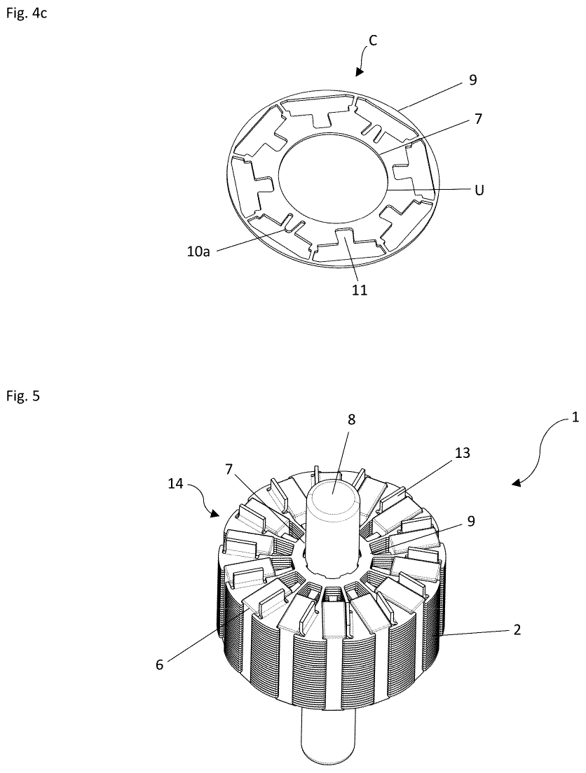

FIG. 4a-c show detailed views of individual laminations (9) according to the first (A), second (B) or third (C) embodiment.

FIG. 4a shows the individual lamination (9) according to a first embodiment (A), which has a receptacle (7) for a motor shaft (8) (not shown here) in the center. At least one clamping tongue (10b) is formed in the receptacle (7), which clamps onto the motor shaft (8) when it is pressed in and fastens the motor shaft (8) in a frictionally engaged and form-fitting manner in the laminated core (2) (not shown here). For example, the permanent magnet can have a groove for a form-fit connection. The individual lamination (9) has magnet-receiving pockets (5) in which permanent magnets (6) are attached. At least one clamping tongue (10a) is provided in at least one magnet-receiving pocket (5), which holds the permanent magnet (6) in the magnet-receiving pocket (5). In the individual laminations (9) at least one fluid channel (11) is formed in at least one magnet-receiving pocket (5). The individual lamination (9) shown here is designed for a T-rotor. Alternatively, the individual lamination (9) can also be designed for a V-rotor or I-rotor, but preferably for an SPM rotor, alternatively also for an IPM rotor. In a further alternative, the individual lamination (9) itself can have at least one fluid channel (11) (not shown here).

FIG. 4b shows the individual lamination (9) according to a second embodiment (B), which has a receptacle (7) for a motor shaft (8) (not shown here) in the center. The receptacle (7) is designed to be uninterrupted in its circumference (U). The individual lamination (9) has magnet-receiving pockets (5) in which permanent magnets (6) are attached. At least one clamping tongue (10a) is provided in at least one magnet-receiving pocket (5), which holds the permanent magnet (6) in the magnet-receiving pocket (5). In the individual laminations (9) at least one fluid channel (11) is formed in at least one magnet-receiving pocket (5). The individual lamination (9) shown here is designed for a T-rotor. Alternatively, the individual lamination (9) can also be designed for a V-rotor or I-rotor, but preferably for an SPM rotor, alternatively also for an IPM rotor.

FIG. 4c shows the individual lamination (9) according to a third embodiment (C), which has a receptacle (7) for a motor shaft (8) (not shown here) in the center. The receptacle (7) is larger in its radial diameter than in the second embodiment (B). The receptacle (7) is also designed to be uninterrupted in its circumference (U). Due to the radially larger diameter of the receptacle (7), a type of recess can be formed in the laminated core, for example, to receive a thrust washer (12) or an additional bearing seat in this recess. In the individual laminations (9) at least one fluid channel (11) is formed in at least one magnet-receiving pocket (5).

FIG. 5 shows a perspective view of a permanent magnet rotor according to another embodiment. As in the previous examples, the permanent magnet rotor (1) comprises at least one laminated core (2) which is formed from at least two sub-cores (3, 4). The laminated core (2) has magnet-receiving pockets (5) in which permanent magnets (6) are received. As a development of the invention, at least one individual lamination (9) has at least one lamination tab (13) on at least one axial end face (14) of the laminated core (2), which tab extends in the axial direction from the laminated core (2). In other words, a section of the individual lamination (9) is bent upwards by 90°after the punching process. The lamination tabs (13) can be arranged directly next to a magnet-receiving pocket (5). It is possible to provide only one lamination tab (13), but lamination tabs (13) can be provided distributed over the entire circumference. In the example of FIG. 5, each magnet-receiving pocket (5) on the individual lamination (9) has a lamination tab. It is conceivable to provide axially protruding lamination tabs (13) on both axial end faces of the permanent magnet rotor (1). The fixation of the projecting permanent magnets and the forced media flow and media turbulence are advantageously further improved.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS

1 permanent magnet rotor
2 laminated core
3 sub-core
4 sub-core
5 magnet-receiving pocket
6 permanent magnet
7 receptacle
8 motor shaft
9 individual lamination
10a clamping tongue
10b clamping tongue
11 fluid bore
12 thrust washer
13 lamination tab
14 end face
A first embodiment
B second embodiment
C third embodiment
U circumference

What is claimed is:

1. A permanent magnet rotor comprising:
at least one laminated core formed from at least two sub-cores,
wherein the laminated core has magnet receiving pockets in which permanent magnets are received,
wherein the laminated core has a receptacle for a motor shaft in its center,
wherein each sub-core is formed by stacking individual laminations and wherein at least one permanent magnet projects from the magnet-receiving pocket in at least one axial direction.

2. The permanent magnet rotor according to claim 1, wherein the individual laminations according to a first embodiment have at least one clamping tongue in at least one magnet receiving pocket and in the receptacle.

3. The permanent magnet rotor according to claim 2, wherein at least one fluid channel is formed in at least one magnet-receiving pocket in the individual laminations.

4. The permanent magnet rotor according to claim 1, wherein the individual laminations according to a second embodiment form the receptacle in its circumference without interruption.

5. The permanent magnet rotor according to claim 1, wherein the individual laminations according to a third embodiment form the receptacle with a larger radial diameter than in the second embodiment.

6. The permanent magnet rotor according to claim 1, wherein each sub-core is of identical design.

7. The permanent magnet rotor according to claim 1, wherein each sub-core is formed from a plurality of individual laminations according to a first embodiment.

8. The permanent magnet rotor according to claim 1, wherein each sub-core is formed from a plurality of individual laminations according to a second embodiment.

9. The permanent magnet rotor according to claim 1, wherein each sub-core is formed from a plurality of individual laminations according to a third embodiment.

10. The permanent magnet rotor according to claim 1, wherein each sub-core is formed from a plurality of individual laminations according to a first or second or third embodiment.

11. The permanent magnet rotor according to claim 1, wherein at least one individual lamination has at least one lamination tab on at least one axial end face of the lamination stack, which tab extends in the axial direction from the laminated core.

12. The permanent magnet rotor according to claim 1, wherein a part of the permanent magnets is received in a first sub-core, and wherein a part of the permanent magnets is received in a second sub-core, and wherein the first sub-core and the second sub-core are joined together to form a laminated core.

13. The permanent magnet rotor according to claim 1, wherein a thrust washer is received on the motor shaft.

14. The permanent magnet rotor according to claim 1, wherein the permanent magnet rotor is used in an electric motor.

15. The permanent magnet rotor according to claim 1, wherein the permanent magnet rotor is used in a fluid pump.
